(19) United States
(12) Patent Application Publication
(10) Pub. No.: US 2021/0232274 A1
(43) Pub. Date: Jul. 29, 2021

(54) ELECTRONIC APPARATUS AND CONTROLLING METHOD THEREOF

(71) Applicant: Samsung Electronics Co., Ltd., Suwon-si (KR)

(72) Inventors: Pius LEE, Suwon-si (KR); Hyunuk TAK, Suwon-si (KR); Junkyu HAN, Suwon-si (KR)

(21) Appl. No.: 17/124,827

(22) Filed: Dec. 17, 2020

(30) Foreign Application Priority Data
Jan. 29, 2020 (KR) 10-2020-0010402

(51) Int. Cl. G06F 3/0482; G06F 9/445; G06F 3/0484; G06F 3/0488

(52) U.S. Cl. CPC G06F 3/0482; G06F 3/04886; G06F 3/04842; G06F 9/445

(57) ABSTRACT

An electronic apparatus is provided. The electronic apparatus includes a display and at least one processor configured to generate menu history information based on a selection history of a menu item included in a menu of an application, based on an event requiring menu display occurring, select a preferred menu item from among a plurality of menu items included in a menu that needs to be displayed based on the menu history information, and control the display to display an object corresponding to the preferred menu item.

### CROSS-REFERENCE TO RELATED APPLICATION(S)

This application is based on and claims priority under 35 U.S.C. § 119(a) of a Korean patent application number 10-2020-0010402, filed on Jan. 29, 2020, in the Korean Intellectual Property Office, the disclosure of which is incorporated by reference herein in its entirety.

### BACKGROUND

### 1. Field

The disclosure relates to an electronic apparatus and a controlling method thereof. More particularly, the disclosure relates to an electronic apparatus that displays a user's preferred menu item and a controlling method thereof.

### 2. Description of Related Art

Recently, an electronic apparatus provides various services to a user using various applications. Most of the applications provided in the electronic apparatus includes a menu related to the applications or contents provided through the applications. In this case, since the type, location and structure of the menu are different for each application, the user needs to find the location of a menu item of a desired function whenever the user uses the application. In particular, when a new application is installed in the electronic apparatus, the user has to suffer inconvenience of searching for menus of the new application or referring to a manual in order to find a desired function in the new application.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a user with a method for easily accessing a menu of an application based on history information of the user selecting a menu item included in the menu of the application.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a display and at least one processor configured to generate menu history information based on a selection history of a menu item included in a menu of an application, based on an event requiring menu display occurring, select a preferred menu item from among a plurality of menu items included in a menu that needs to be displayed based on the menu history information, and control the display to display an object corresponding to the preferred menu item.

In accordance with another aspect of the disclosure, a controlling method of an electronic apparatus is provided. The controlling method of an electronic apparatus includes generating menu history information based on a selection history of a menu item included in a menu of an application, based on an event requiring menu display occurring, selecting a preferred menu item from among a plurality of menu items included in a menu that needs to be displayed based on the menu history information, and displaying an object corresponding to the preferred menu item.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic apparatus according to an embodiment of the disclosure;

FIG. 2 is a view illustrating menu history information according to an embodiment of the disclosure;

FIG. 3 is a view illustrating menu history information according to an embodiment of the disclosure;

FIG. 4 is a view illustrating an electronic apparatus that displays a preferred menu item according to an embodiment of the disclosure;

FIG. 5 is a view illustrating an electronic apparatus that generates recommended menu information for a new application according to an embodiment of the disclosure;

FIG. 6 is a view illustrating an electronic apparatus that updates menu history information according to an embodiment of the disclosure;

FIG. 7 is a view illustrating an electronic apparatus that updates menu history information using menu history information of a plurality of apparatuses according to an embodiment of the disclosure;

FIG. 8 is a block diagram illustrating a configuration of an electronic apparatus according to an embodiment of the disclosure; and

FIG. 9 is a flowchart illustrating a controlling method of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the terms “have”, “may have”, “comprise”, or “may comprise” designate the presence of the corresponding features (e.g., numbers, functions, operations or components, such as parts, and the like), but do not exclude the presence of additional features.

In the description, expressions, such as “A or B”, “at least one of A and/or B”, or “one or more of A and/or B” may include all possible combinations of the items listed together. For example, “A or B”, “at least one of A and/or B”, or “one or more of A and/or B” may refer to the cases of (1) including at least one A, (2) including at least one B, or (3) including at least one A and at least one B.

Expressions “first”, “second”, or the like, used in the disclosure may indicate various components regardless of a sequence and/or importance of the components, will be used only in order to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled with/to another component or may be coupled with/to another component through the other component (for example, a third component). On the other hand, when it is mentioned that any component (for example, a first component) is “directly coupled with/to” or “directly connected to” to another component (for example, a second component), it is to be understood that the other component (for example, a third component) is not present between any component and another component.

An expression “configured (or set) to” used in the disclosure may be replaced by an expression “suitable for”, “having the capacity to”, “designed to”, “adapted to”, “made to”, or “capable of” depending on a situation. A term “configured (or set) to” may not necessarily mean only “specifically designed to” in hardware. Instead, an expression “an apparatus configured to” may mean that the apparatus is “capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

An electronic device according to the various embodiments of the disclosure may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a kiosk, a medical device, a camera, or a wearable device. In addition, the wearable device may include at least one of an accessory-type device (e.g., a watch, a ring, a bracelet, an ankle bracelet, a necklace, glasses, a contact lens, or a head-mounted-device (HMD)), a device integrated with fabrics or clothing (e.g., electronic clothing), a body-attached device (e.g., a skin pad or a tattoo), or an implantable circuit. In addition, in some embodiments of the disclosure, an electronic device according to various embodiments of the disclosure may include at least one of, for example, a television, a digital video disk (DVD) player, an audio, a refrigerator, an air conditioner, a cleaner, an oven, a microwave oven, a washing machine, an air cleaner, a set top box, a home automation control panel, a security control panel, a media box, a game console, an electronic dictionary, an electronic key, a camcorder, or an electronic photo frame.

Meanwhile, in this disclosure, the term ‘a user’ may refer to a person using an electronic apparatus or a device using an electronic apparatus (e.g., an artificial intelligence electronic apparatus). In addition, the electronic apparatus according to the disclosure may include an artificial intelligence learning model.

Hereinafter, the disclosure will be described in detail with reference to drawings.

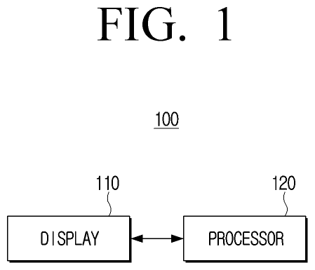

FIG. 1 is a block diagram illustrating configuration of an electronic apparatus according to an embodiment of the disclosure.

Referring to FIG. 1, an electronic apparatus 100 includes a display 110 and a processor 120.

The display 110 may provide a screen of various applications that can be provided to a user through the electronic apparatus 100. The display 110 may provide a screen including various contents and graphic user interfaces (GUIs), such as images, videos, texts, music, and the like, as an application is executed.

The display 110 may be implemented as various types of displays, such as liquid crystal display (LCD), organic light emitting diodes (OLED) display, plasma display panel (PDP), Wall, Micro light emitting diodes (LED), and the like. The display 110 may include a driving circuit, a backlight unit, and the like, that can be implemented in the form of a-si TFT, low temperature poly silicon (LTPS) TFT, organic thin film transistor (OTFT), and the like. In addition, the display 110 may be implemented as a touch screen combined with a touch sensor, a flexible display, a 3 dimensional (3D) display, and the like.

In addition, the display 110 according to an embodiment may include not only a display panel that outputs an image but also a bezel that houses a display panel. In particular, the bezel according to an embodiment may include a touch sensor (not shown) for sensing a user interaction.

The processor 120 may be electrically connected to a memory (not shown) and control the overall operations and functions of the electronic apparatus 100. For example, the processor 120 may control hardware or software components connected to the processor 120 and perform various data processing and computation by driving an operating system or an application program. In addition, the processor 120 may load commands or data received from at least one of other components onto a volatile memory and process the same, and may store various data in a non-volatile memory.

To this end, the processor 120 may be implemented as a general-purpose processor (e.g., Central Processing Unit (CPU)) or an application processor that can perform the corresponding operations by executing a processor dedicated to perform the corresponding operation (e.g., an embedded processor) or one or more software programs stored in a memory device.

According to an embodiment of the disclosure, the processor 120 may be implemented by a digital signal processor (DSP) processing a digital signal, a microprocessor, or a time controller (TCON). However, the processor 120 is not limited thereto, but may include one or more of a central processing unit (CPU), a micro controller unit (MCU), a micro processing unit (MPU), a controller, an application processor (AP), a graphics-processing unit (GPU) or a communication processor (CP), or an ARM processor, or may be defined by these terms. In addition, the processor 120 may be implemented by a system-on-chip (SoC) or a large scale integration (LSI) in which a processing algorithm is embedded or may be implemented in a field programmable gate array (FPGA) form.

The processor 120 may execute an application. Here, the application may be not only an application installed in the electronic apparatus 100 when the electronic apparatus 100 is manufactured but also an application downloaded by the electronic apparatus 100 through a server or a network.

The processor 120 may control the display 110 to display a menu of an application. The menu in the disclosure represents a list of items for setting the execution environment (e.g., sound, screen, color, color weakness, time, theme, vibration, notification, and the like) of the application or the environment of contents (e.g., ‘character’ of a game application, ‘subtitles’ of a video application, and the like) through the application. However, the disclosure is not limited thereto, and the menu in the disclosure may represent various lists of items related to an application and contents and GUIs provided in the application.

When an event requiring display of the menu of an application occurs, the processor 120 may control the display 110 to display the menu of the application. For example, if a user selects an object or a text displayed on the execution screen of an application, taps the display 110, or performs the operation of shaking the electronic apparatus 100 while the application is executed, the processor 120 may control the display 110 to display the menu of the application.

The processor 120 may receive a user input of selecting at last one of menu items included in the menu displayed on the display 110.

Subsequently, the processor 120 may generate menu history information based on the history of a user's selection regarding the menu items. Here, the menu history information is information that is generated when the user selects at least one menu item included in the menu, and may include menu items selected by the user, menu items selected before/after the selected menu item, and weight information according to the number of selection.

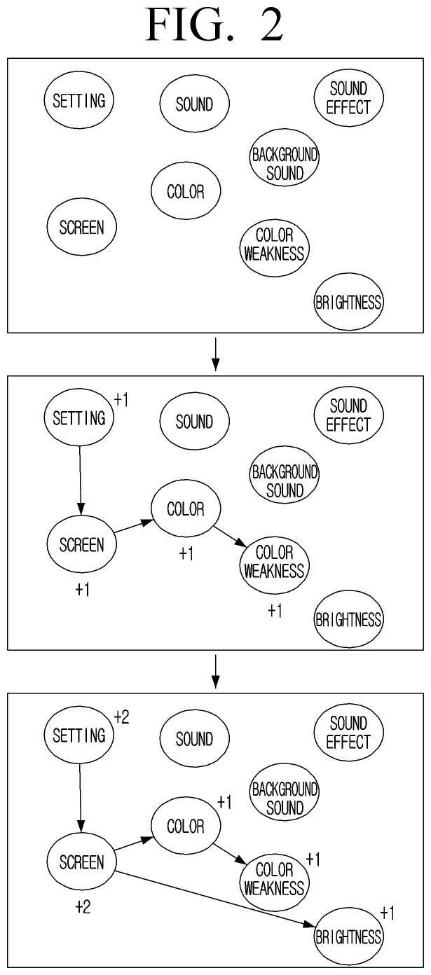

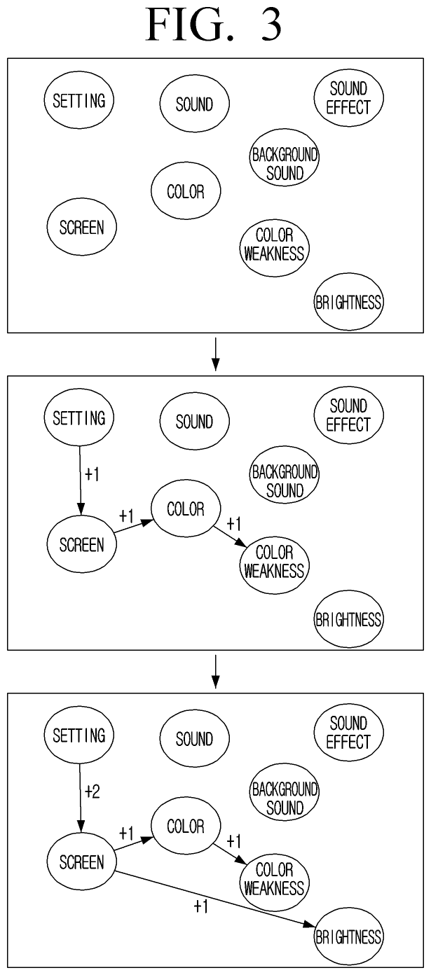

The menu history information will be described with reference to FIGS. 2 and 3.

The processor 120 may generate the menu history information of an application using resources related to the menu of the application. To this end, the processor 120 may obtain resources related to the menu of the application from an installation file of the application. In the disclosure, the resources related to the menu of the application may represent at least one of text information, image information, icon information, extensible markup language (XML) data information or code information related to the menu of the application. The menu may include menu items and sub menu items that are sub concepts of each menu item, and the text information, image information, icon information, XML data information and code information of the menu items or the sub menu items may be resources related to the menu of the application.

The processor 120 may generate menu history information including information regarding the menu items or sub menu items based on the resources obtained from the application file.

The processor 120 may identify menu items or sub menu items, such as ‘setting’, ‘screen’, ‘sound’, ‘color’, ‘brightness’, ‘background sound’, ‘color weakness’, and the like, in the menu based on the resource information, generate a node including resource information for each of the above, and generate menu history information including the generated node. For example, the processor 120 may generate a ‘setting’ node including text, image, icon, XML data and code information related to a ‘setting’ menu item.

The processor 120 may generate menu history information based on the resource information of a menu item or a sub menu item selected by the user in the menu.

FIG. 2 is a view illustrating menu history information according to an embodiment of the disclosure.

Referring to FIG. 2, the processor 120 may generate menu history information by assigning a weight to each of the menu item and the sub menu item related to the menu item selected in the menu. The weight value may be determined based on the number of times of the menu item selected by the user, but is not limited thereto.

For example, if the menu item of ‘setting’ and the sub menu items of ‘screen’, ‘color’, and ‘color weakness’ are selected sequentially by the user, the processor 120 may recognize that ‘setting’, ‘screen’, ‘color’, and ‘color weakness’ are selected sequentially in the menu based on the resource information of ‘setting’, ‘screen’, ‘color’, and ‘color weakness’, and increase the weight value of the node of ‘setting’, ‘screen’, ‘color’, and ‘color weakness’ of the menu history information by 1. Alternatively, if the menu item of ‘setting’ and the sub menu items of ‘screen’ and ‘brightness’ are selected sequentially by the user, the processor 120 may recognize that ‘setting’, ‘screen’ and ‘brightness’ are selected sequentially in the menu based on the resource information of ‘setting’, ‘screen’ and ‘brightness’, and increase the weight value of the node of ‘setting’, ‘screen’ and ‘brightness’ of the menu history information by 1.

In this case, the processor 120 may identify a menu item that is selected by the user frequently through the weight value of the leaf node (e.g., the menu items of ‘color weakness’ and ‘brightness’) in which a sub node does not exist any longer. For example, if the weight value of ‘color weakness’ is higher than the weight value of ‘brightness’, the processor 120 may determine that the preference of the menu item of ‘color weakness’ is higher than the preference of the menu item of ‘brightness.’

FIG. 3 is a view illustrating menu history information according to an embodiment of the disclosure.

Meanwhile, referring to FIG. 3, the processor 120 may generate menu history information by assigning a weight to the connection between a menu item selected in the menu and at least one sub menu item related to the selected menu item.

For example, if the menu item of ‘setting’ and the sub menu items of ‘screen’, ‘color’ and ‘color weakness’ are selected sequentially by the user, the processor 120 may recognize that ‘setting’, ‘screen’, ‘color’, and ‘color weakness’ are selected sequentially in the menu based on the resource information of ‘setting’, ‘screen’, ‘color’, and ‘color weakness’, and assign a weight to the connection of ‘setting-screen’, ‘screen-color’, and ‘color-color weakness.’ Alternatively, if the menu item of ‘setting’ and the sub menu items of ‘screen’ and ‘brightness’ are selected sequentially by the user, the processor 120 may recognize that ‘setting’, ‘screen’ and ‘brightness’ are selected sequentially in the menu based on the resource information of ‘setting’, ‘screen’ and ‘brightness’, and assign a weight to the connection of ‘setting-screen’ and ‘screen-brightness’ in the menu history information.

As in FIG. 2, a weight value assigned to the connection between nodes may be determined based on the number of times of the menu item selected by the user, but is not limited thereto.

As such, when a weight is assigned to the connection between a menu item and a sub menu item, the processor 120 may identify a menu item that is selected by the user frequently through the sum of the weight values of at least one connection to a leaf node (e.g., the menu items of ‘color weakness’ and ‘brightness’) in which a sub node does not exist any longer. For example, if the sum of weight values of the connection to the menu item of ‘color weakness’ is greater than the sum of the weight values of the connection to the menu item of ‘brightness’, the processor 120 may determine that the preference of the menu item of ‘color weakness’ is higher.

Meanwhile, the processor 120 may generate menu history information based on the history of selecting a menu item included in the menu of a plurality of applications.

For example, even in the case where the menu item of ‘setting’ and the sub menu items of ‘screen’, ‘color’ and ‘color weakness’ are selected sequentially in the menu of application A and the menu item of ‘setting’ and the sub menu items of ‘screen’ and ‘brightness’ are selected sequentially in the menu of application B, the menu history information as in FIG. 2 or FIG. 3 may be generated.

Meanwhile, if the electronic apparatus 100 is an apparatus including an artificial intelligence model, the menu history information may be implemented as an artificial intelligence learning model.

The processor 120 may recommend a menu item to a user based on the generated menu history information.

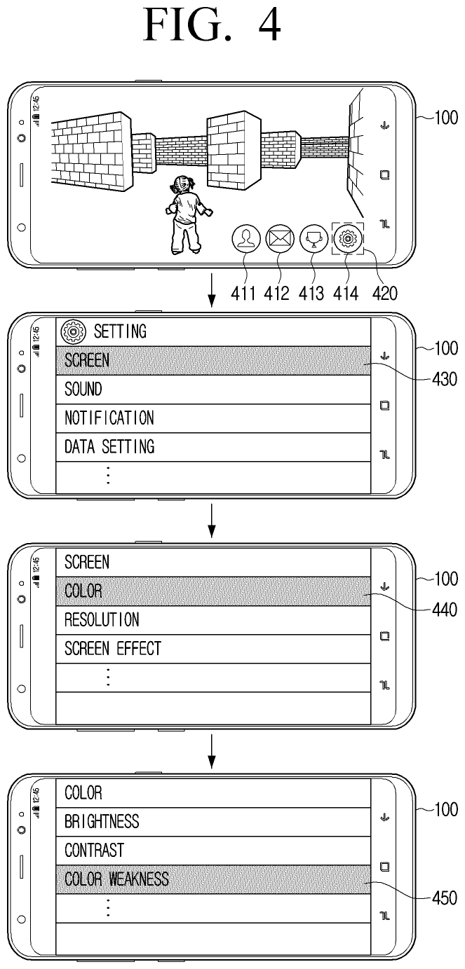

FIG. 4 is a view illustrating an electronic apparatus that displays a preferred menu item according to an embodiment of the disclosure.

In relation to the above, FIG. 4 is a view illustrating an electronic apparatus that displays a preferred menu item according to an embodiment. Specifically, the processor 120 may provide a user with information on a preferred menu item from among a plurality of menu items based on the generated menu history information.

Referring to FIG. 4, if an event that requires a menu display, such as a user's tapping a display screen or shaking the electronic apparatus 100 occurs while a game application is executed, the processor 120 may display a menu including an icon 411 corresponding to the menu item of ‘account’, an icon 412 corresponding to the menu item of ‘note’, an icon 413 corresponding to the menu item of ‘ranking’, and an icon 414 corresponding to the menu item of ‘setting’ included in the menu of the game application.

Subsequently, the processor 120 may select a preferred menu item from among a plurality of menu items included in the menu based on the menu history information and control the display 110 to display an object corresponding to the selected preferred menu item.

In relation to the above, if a weight is assigned to menu items as illustrated in FIG. 2, the processor 10 may select a menu item having the highest weight from among the weight values assigned to the menu items as a preferred menu item. On the other hand, if a weight is assigned to a connection between menu items as illustrated in FIG. 3, the processor 120 may select a menu item having the highest weight value from among weight values of the connection to each menu item as a preferred menu item.

For example, if it is determined that the weight information of ‘setting’ is the highest from among the menu items of ‘account’, ‘note’, ‘ranking’, and ‘setting’, the processor 120 may select the menu item of ‘setting’ as a referred menu item, and control the display 110 to display an object 420 corresponding to ‘setting.’ In FIG. 4, the object 420 is displayed as a figure, but it is not limited thereto. The object 420 may include at least one of a highlight, preference information and an image regarding a preferred menu item. In this case, the preference information may be information corresponding to a weight value of the preferred menu item in the menu history information.

If one of the displayed menu items is selected, the processor 120 may search and display a sub menu item related to the selected menu item, identify a sub menu item having the highest preference from among sub menu items, and control the display 110 to display an object corresponding to the identified sub menu item.

Specifically, if menu history information is generated by assigning a weight to menu items as described above with reference to FIG. 2, when one of the menu items (e.g., the menu item of ‘setting’) included in the displayed menu is selected, the processor 120 may control the display 110 to display a sub menu item (e.g., the sub menu items of ‘screen’, sound’, ‘notification’, and ‘data setting’) related to the selected menu item based on the menu history information, identify a sub menu item having the highest score (e.g., the sub menu item of ‘screen’) from among the displayed sub menu items and display an object 430 corresponding to the identified sub menu item.

On the other hand, if menu history information is generated by assigning a weight to a connection between menu items as described above with reference to FIG. 3, when one of the menu items (e.g., the menu item of ‘setting’) included in the displayed menu is selected, the processor 120 may search and display a sub menu item (e.g., the sub menu items of ‘screen’, ‘sound’, ‘notification’, and ‘data setting) related to the selected menu item based on the menu history information, and control the display 110 to display the object 430 corresponding to the sub menu item having the highest score of connection to the menu item (e.g., the sub menu item of ‘screen’) from among the retrieved sub menu items.

The processor 120 may repeat the operation of displaying a sub menu item having the highest preference until no sub menu item exists. For example, after the sub menu item of ‘screen’ is selected, the processor 120 may identify that the preference of ‘color’ is high from among ‘color’, resolution’ and ‘screen effect’ which are sub menu items of ‘screen’ based on the menu history information and display an object 440 corresponding to ‘color.’ Likewise, the processor 120 may identify that the preference of ‘color weakness’ is high from among the sub menu items of ‘color’ based on the menu history information and display an object 450 corresponding to ‘color weakness.’

Meanwhile, unlike FIG. 4, if a user selects ‘sound’ instead of ‘screen’ which has the highest preference among the sub menu items of the menu item of ‘setting’, the processor 120 may identify a sub menu item having the highest preference from among sub menu items (not illustrated) of ‘sound’, and control the display 110 to display an object corresponding to the identified sub menu item.

As such, the processor 120 may identify a menu item and a sub menu item having the highest preference of the user based on the menu history information, and display them differently from other menu items and sub menu items, making it easier for the user to identify a preferred menu item.

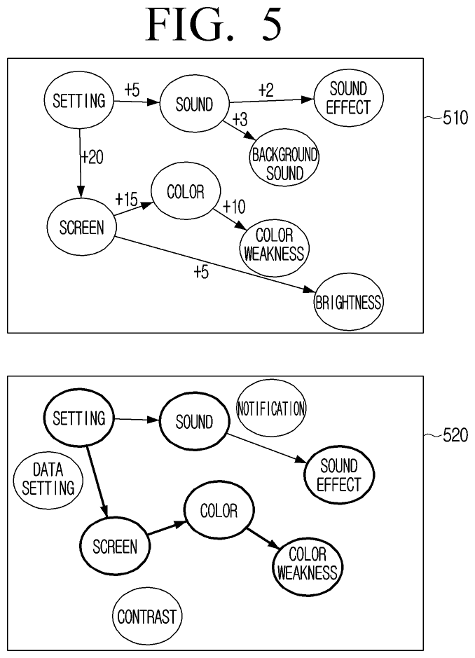

In particular, eve in the case where a new application is installed in the electronic apparatus 100, the processor 120 may identify a menu item and a sub menu item having the highest user preference based on the menu history information, and display the menu item of the new application corresponding to the user's preferred menu item and sub menu item differently from other menu items, which will be described in detail with reference to FIG. 5.

FIG. 5 is a view illustrating an electronic apparatus that generates recommended menu information for a new application according to an embodiment of the disclosure.

Referring to FIG. 5, menu history information 510 represents menu history information that is generated based on the resource information of at least one application installed in the electronic apparatus 100 and the user's selection history.

When a new application is installed, the processor 120 may obtain from an application file menu information of the new application. Specifically, the processor 120 may obtain resource information, such as text information, image information, icon information, XML data information, and code information of a menu item or a sub menu item of the new application.

In addition, the processor 120 may generate recommended menu information 520 regarding the new application by matching the menu history information 510 and the menu information obtained from the new application.

Specifically, the processor 120 may identify a menu item that is the same as a menu item (or a sub menu item) included in the menu history information from among menu items included in the menu of the new application by comparing the resource information included in the menu items (or the sub menu items) of the menu history information with the resource information included in the menu information of the new application.

For example, according to an embodiment illustrated in FIG. 5, the processor 120 may identify the menu items same as the menu items (or the sub menu items) included in the menu history information from among the menu items of the new application are ‘setting’, ‘sound’, ‘screen’, ‘color’, ‘sound effect’, and ‘color weakness’ by comparing the resource information of the menu items included in the menu history information with the resource information of the menu items of the new application.

The processor 120 may generate the recommended menu information 520 regarding the new application by connecting the menu items of the new application based on the connection relation between the menu items and the sub menu items in the menu history information 510. For example, the processor 120 may connect the menu items of ‘setting’ and ‘sound’ from among the menu items of the new application using the menu history information 510. Likewise, the processor 120 may generate the recommended menu information 520 by connecting ‘sound’ and ‘sound effect’, ‘setting’ and ‘screen’, ‘screen’ and ‘color’, and ‘color’ and ‘color weakness.’

Meanwhile, this is only an example, and the processor 120 may connect menu items of the new application in a method different from the above-described method. Specifically, the processor 120 may determine menu structure information of the new application, and connect menu items based on the determined menu structure information.

For example, the processor 120 may determine that there are ‘sound’, ‘screen’ and ‘data setting’ as the sub menu items of menu item of ‘setting’, ‘sound effect’ and ‘notification’ as the sub menu items of ‘sound, ‘color’ and ‘contrast’ as the sub menu items of ‘screen’, and ‘color weakness’ as the sub menu item of ‘color’, and connect the menu items same as the menu items of the menu history information 510 based on the location information of the determined items.

The processor 120 may identify a recommended item of the new application using weight information of the menu history information 510.

Specifically, as described above with reference to FIG. 3, the processor 120 may identify that the user's preferred menu item is ‘color weakness’ based on score information of the edge connected to the lowermost sub menu item in the menu history information 510. The processor 120 may identify the menu item of ‘color weakness’ corresponding to the identified preferred menu item in the menu history information 510 from among the menu items of the recommended menu information 520 as a recommended item.

The processor 120 may control the display 110 to display an object in at least one menu item from among a plurality of menu items included in the menu of the new application based on the connection between the menu items in the recommended menu information 520. The description thereof overlaps with the above description of FIG. 4 and thus, specific description thereof will be omitted.

As such, when a new application is installed in the electronic apparatus 100, the processor 120 may identify a user's preferred menu item from among menu items of the new application based on the menu selection history information of an application pre-installed in the electronic apparatus 100 and recommend the same to the user. Accordingly, the user may easily find a preferred menu item without the inconvenience of searching a menu of the new application or searching a manual of the application.

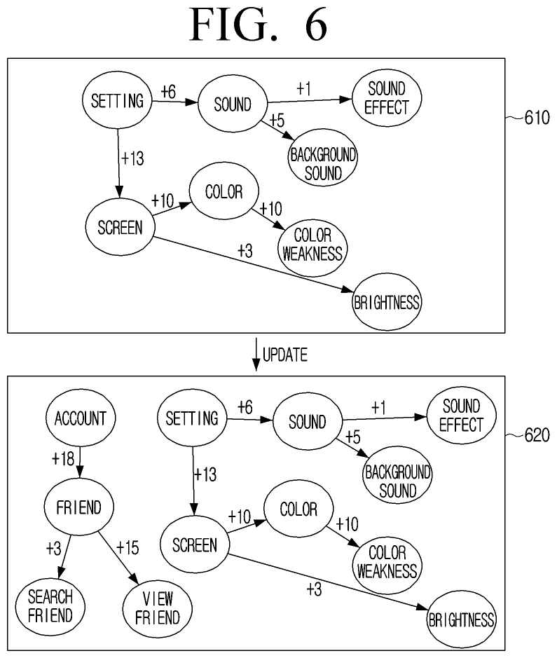

Meanwhile, if a menu item of the new application is selected by the user after then new application is installed, the processor 120 may update menu history information, which will be described in detail with reference to FIG. 6.

FIG. 6 is a view illustrating an electronic apparatus that updates menu history information according to an embodiment of the disclosure.

Referring to FIG. 6, if a menu item that is not included in menu history information 610 from among the menu items of the application installed in the electronic apparatus 100 is selected, the processor 120 may update the menu history information 610 using the resource information of the selected menu item. Specifically, the processor 120 may generate a node including the resource information of the selected menu item, and add the generated node to the menu history information 610. In addition, the processor 120 may assign a weigh to the connection of generated nodes based on the order of the menu items selected by the user. For example, if the user selects the menu items of ‘account’, ‘friend’, and ‘search a friend’ of the new application sequentially, the processor 120 may recognize that ‘account’, ‘friend’ and ‘search a friend’ are selected sequentially in the menu of the new application based on the resource information of the menu items of ‘account’, ‘friend’ and ‘search a friend’, and assign a weight to the connection of the nodes, ‘account-friend’ and ‘friend-search a friend’ corresponding to the menu item of ‘account’ in the menu history information.

Menu history information 620 represents menu history information that is updated as the user selects a new menu item of the application.

Meanwhile, in the menu history information 620 of FIG. 6, it is illustrated that the node of ‘account’ and the node of ‘setting’ is not connected, but if the user selects the menu items of ‘account’ and ‘setting’ sequentially, a weight may be assigned to the connection of the nodes ‘account-setting.’

Meanwhile, the processor 120 may update the menu history information of the processor 120 using menu history information of other apparatuses.

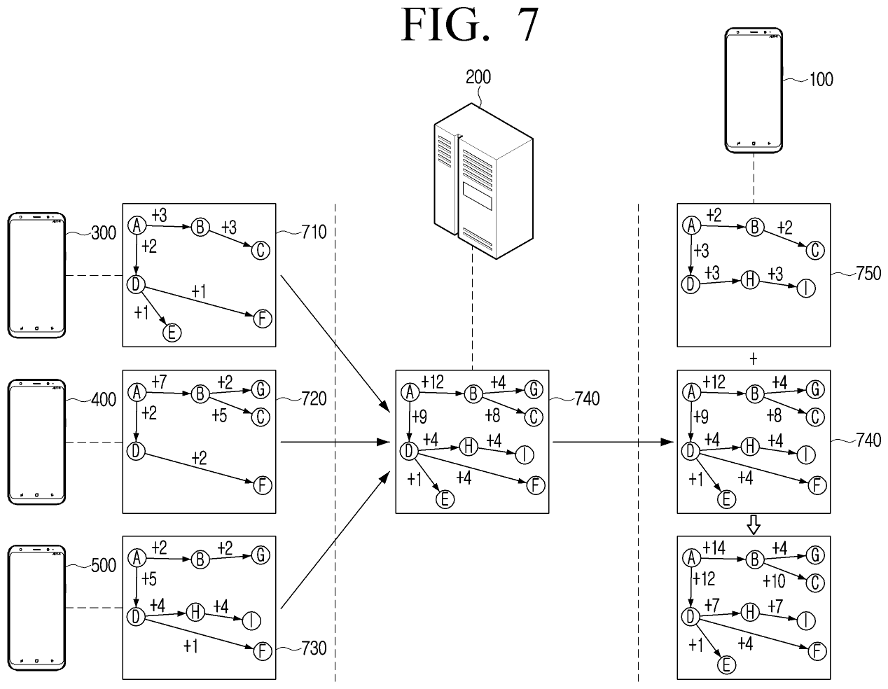

FIG. 7 is a view illustrating an electronic apparatus that updates menu history information using menu history information of a plurality of apparatuses according to an embodiment of the disclosure.

In relation to the above, FIG. 7 is a view illustrating an electronic apparatus that updates menu history information by receiving menu history information of a plurality of apparatuses from a server. Due to the limitation of the drawing, the values of the nodes included in the menu history information (710, 720, 730, 740, 750, 760) are written in English alphabet, but the value of each node included in the menu history information (710, 720, 730, 740, 750, 760) may correspond to the menu item included in the menu of the application.

The server 200 may receive a plurality of pieces of menu history information (710, 720, 730) from each of a plurality of apparatuses (300, 400, 500). The server 200 may generate menu history information 740 regarding the plurality of apparatuses by combining the plurality of pieces of menu history information (710, 720, 730) received from the plurality of apparatuses (300, 400, 500).

Referring to FIG. 7, the plurality of apparatuses (300, 400, 500) are illustrated as smart phones, but they are not limited thereto. Each of the plurality of apparatuses may be at least one of smart phone, tablet PC, mobile phone, video phone, e-book reader, desktop PC, laptop PC, netbook computer, workstation, kiosk, television (TV), medical device, camera, or wearable device. In addition, each of the plurality of apparatuses does not necessarily have to be the same apparatus, and may be different apparatuses. For example, the apparatus 300 may be a smart phone, the apparatus 400 may be a TV, and the apparatus 500 may be a tablet PC.

In addition, the server 200 may receive menu history information not only from the plurality of apparatuses (300, 400, 500) but also from the electronic apparatus 100. For example, if there is an information sharing agreement from the user of the electronic apparatus 100, the processor 120 may provide menu history information to the server 200.

When receiving menu history information regarding the plurality of apparatuses (300, 400, 500) from the server 200 through a communication interface (not illustrated), the processor 120 may update the menu history information of the electronic apparatus 100 based on the received menu history information.

If the processor 120 may receive the menu history information 740 from the server 200, the processor 120 may update the menu history information 760 by combining the menu history information 750 stored in a memory (not illustrated) with the menu history information 740 received from the server.

Meanwhile, the processor 120 may store each of the previous menu history information 750 of the electronic apparatus 100 and the updated menu history information 760 in the memory (not illustrated), and selectively use the previous menu history information 750 and the updated menu history information 760.

In addition, the processor 120 may identify the user's preferred menu item through the updated menu history information 760, and control the display 110 to display an object in the identified preferred menu item.

As such, by receiving the menu history information of the plurality of apparatuses, the electronic apparatus 100 may determine the user's preferred menu more accurately based on the menu history information of the user who uses the plurality of electronic apparatuses and thus, may provide a recommended menu suitable for the user.

Meanwhile, FIG. 7 illustrates that the processor 120 receives menu history information from the server, but the processor 120 may receive the menu history information (710, 720, 730) from each of the plurality of apparatus (300, 400, 500) through the communication interface (not illustrated), and update the menu history information based on the received menu history information (710, 720, 730) and the menu history information 740 of the electronic apparatus 100.

If the electronic apparatus 100 is an apparatus including an artificial intelligence model, the process of updating menu history information in FIGS. 6 and 7 may correspond to the process of retraining the artificial intelligence model.

Meanwhile, FIGS. 5 to 7 of the disclosure merely illustrate an embodiment in which a weight is assigned to a connection between menu items or sub menu items, but the same method can be applied when a weight is assigned to each of the menu items or the sub menu items. The description regarding an embodiment in which a weight is assigned to menu items will be omitted in order to avoid overlapping of the same contents.

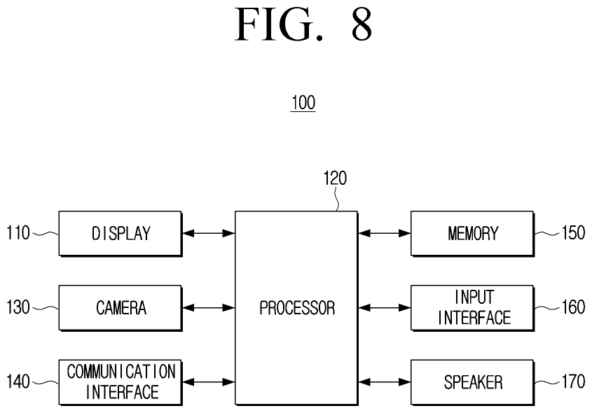

FIG. 8 is a view illustrating detailed configuration of an electronic apparatus according to an embodiment of the disclosure.

Referring to FIG. 8, the electronic apparatus 100 may include the display 110, a camera 130, a communication interface 140, a memory 150, an input interface 160, a speaker 170, and the processor 120. The detailed description regarding the components of FIG. 8 which are overlapped with the components of FIG. 1 will be omitted.

The camera 130 may photograph an arbitrary subject under the control of the processor 120, and transmit the photographed data to the processor 120. The photographed data may be stored in the memory 150 under the control of the processor 10. The camera may be positioned on the front side or the rear side of the electronic apparatus 100.

The camera 130 is a device capable of photographing a still image and a video image, and may include one or more image sensors (e.g., a front sensor or a rear sensor), lens, an image signal processor (ISP), and a flash (e.g., LED, Xenon lamp, and the like).

The communication interface 140 is a component for the electronic apparatus 100 to perform communication with an external device, such as the server 200 and other devices (300, 400, 500). As described above with reference to FIG. 7, the processor 120 may receive menu history information from the server 200 or other devices (300, 400, 500) through the communication interface 140.

The communication interface 140 may include various communication modules, such as a wired communication module (not illustrated), a nearfield wireless communication module (not illustrated), a wireless communication module (not illustrated), and the like.

Here, the wireless communication module is a module for performing communication with an external device (not illustrated) according to a wireless communication method, such as Ethernet. The nearfield wireless communication module is a module for performing communication with an external device (not illustrated) located nearby according to a nearfield wireless communication method, such as Bluetooth (BT), Bluetooth low energy (BLE), Zigbee, and the like. In addition, the wireless communication module is a module that is connected to an external network according to a wireless communication protocol, such as wireless fidelity (WiFi), Institute of Electrical and Electronics Engineers (IEEE), and the like, to perform communication with an external device (not illustrated) and a voice recognition server (not illustrated). In addition, the wireless communication module may further include a mobile communication module that is connected to a mobile communication network according to various mobile communication standards, such as 3^{rd} generation (3G), 3^{rd} generation partnership project (3GPP), long term evolution (LTE), LTE advanced (LTE-A), 5^{th} Generation (5G) Networks, and the like, to perform communication.

The memory 150 may store commands or data required for the operation of the electronic apparatus 100. The memory 150 can be implemented as a non-volatile memory, a volatile memory, a flash-memory, a hard disc drive (HDD), a solid state drive (SSD), and the like. The memory 150 can be accessed by the processor 120, and reading/recording/correction/deletion, and the like, of data by the processor 120 may be performed. In this disclosure, the term ‘a memory’ may include the memory 150, a read only memory (ROM) (not shown) inside the processor 120, a random access memory (RAM) (not shown) or a memory card (not shown) (e.g., a micro secure digital (SD) card, a memory stick) mounted on the electronic apparatus 100.

The memory 150 may store menu history information of the electronic apparatus 100. In addition, the memory 150 may store various applications executable in the electronic apparatus 100 and information thereof. The memory 150 may include an artificial intelligence learning model.

The input interface 160 may receive a user input to control the electronic apparatus 100. The input interface 160 may include not only a keyboard and a mouse but also a microphone to receive a user voice, a touch panel to receive a user touch using a user's hand, a stylus pen, and the like, a button to receive a user manipulation, a motion input unit to detect a user's motion, and the like.

The speaker 170 is a component that outputs various alarm sounds or voice messages in addition to various audio data for which various processing, such as decoding, amplification and noise filtering by an audio processor. Meanwhile, the component for outputting an audio may be implemented as a speaker, but this is only an example. The component for outputting an audio may be implemented as an output terminal that can output audio data.

In addition, the electronic apparatus 100 may add necessary components. In addition, the electronic apparatus 100 does not necessarily include all of the above-described components, and may omit some components, if necessary.

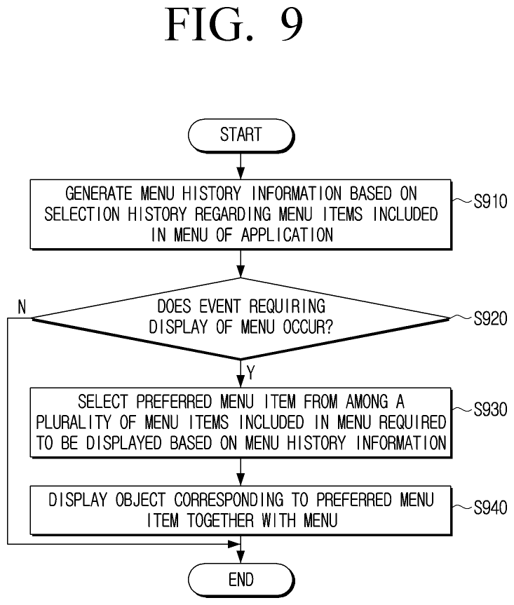

FIG. 9 is a view illustrating a controlling method of an electronic apparatus according to an embodiment of the disclosure.

Referring to FIG. 9, firstly, menu history information is generated based on the selection history of menu items included in a menu in operation S910. The menu history information is information that is generated when a user selects at least one menu item included in the menu, and may include the menu item selected by the user, the menu item selected before/after the selected menu item and weight information according to the number of times of selection.

In this case, the menu history information may be generated by assigning weight to each of the menu item selected in the menu and the sub menu item related to the selected menu item. Meanwhile, this is only an example, and the menu history information may be generated by assigning a score to a connection between the menu item selected in the menu and the selected sub menu item from among at least one sub menu item related to the selected menu item.

In addition, the menu history information may be generated based on menu information on not only one application but also a plurality of applications. Specifically, the menu history information may be generated based on the selection history of menu items included in the menu of a plurality of applications.

When an event requiring menu display occurs in operation S920-Y, a preferred menu item may be selected from among a plurality of menu items included in the menu that needs to be displayed based on the menu history information in operation S930.

Subsequently, an object corresponding to the preferred menu item may be displayed together with the selected menu in operation S940. In this case, the object may include at least one of the highlight, preference information and image regarding the preferred menu item.

Specifically, when a weight is assigned to a menu item and a sub menu item, if the menu item is selected, the sub menu item related to the selected menu item is searched and displayed based on the menu history information, the sub menu item with the highest score from among sub menu items is identified, and an object corresponding to the identified sub menu item may be displayed.

In addition, when a weight is assigned to a connection between a menu item and a sub menu item, if the menu item is selected, the sub menu item related to the selected menu item is searched and displayed based on the menu history information, the sub menu item with the highest connection score with the selected menu item from among retrieved sub menu items is identified, and an object corresponding to the identified sub menu item may be displayed.

Meanwhile, the menu history information may be updated. Specifically, if a menu item included in the menu is selected by the user, the menu history information may be updated based on the information on the selected menu item.

In addition, when menu history information regarding a plurality of apparatuses is received from a server, the generated menu history information may be updated based on the received menu history information. In this case, the menu history information regarding a plurality of apparatuses received from the server may be information incorporating the menu history information that the server receives from the plurality of apparatuses. However, this is only an example, and the menu history information of the electronic apparatus may be updated by receiving menu history information from each of the plurality of apparatuses without going through the server.

Meanwhile, when a new application is installed, menu information of the new application may be obtained, and recommended menu information of the new application may be generated by matching the menu history information stored in the electronic apparatus and the obtained menu information of the new application. In addition, an object may be displayed on at least one menu item from among a plurality of menu items included in the menu of the new application based on the recommended menu information.

Meanwhile, computer instructions for performing processing operations in the electronic apparatus 100 according to the diverse embodiments of the disclosure described above may be stored in a non-transitory computer-readable medium. The computer instructions stored in the non-transitory computer-readable medium cause a specific device to perform the processing operations of the electronic apparatus 100 according to the diverse embodiments described above when they are executed by a processor of the specific device.

The non-transitory computer-readable medium is not a medium that stores data for a while, such as a register, a cache, a memory, or the like, but means a medium that semi-permanently stores data and is readable by the device. Specifically, the above-described various applications or programs may be stored and provided in the non-transitory computer-readable medium, such as a compact disk (CD), a digital versatile disk (DVD), a hard disk, a Blu-ray disk, a USB, a memory card, a ROM, and the like.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic apparatus comprising:
a display; and
at least one processor configured to:
generate menu history information based on a selection history of a menu item included in a menu of an applications
based on an event requiring menu display occurring, select a preferred menu item from among a plurality of menu items included in a menu that needs to be displayed based on the menu history information, and
control the display to display an object corresponding to the preferred menu item,
wherein the at least one processor is further configured to, based on a new application being installed:
obtain menu information of the new application,
generate recommended menu information regarding the new application by matching the menu history information and the obtained menu information, and
control the display to display an object in at least one menu item from among a plurality of menu items included in a menu of the new application based on the recommended menu information.

2. The apparatus of claim 1,
wherein the menu includes a sub menu item related to a menu item included in the menu, and
wherein the at least one processor is further configured to generate the menu history information by assigning a score to each of a menu item selected in the menu and a sub menu item related to the selected menu item.

3. The apparatus of claim 2, wherein the at least one processor is further configured to, based on a menu item included in the menu being selected:
search and display sub menu items related to the selected menu item,
identify a sub menu item with a highest score from among the sub menu items, and
control the display to display an object corresponding to the identified sub menu item.

4. The apparatus of claim 1,
wherein the menu includes a sub menu item related to a menu item included in the menu, and
wherein the at least one processor is further configured to generate the menu history information by assigning a score to each connection between a menu item selected in the menu and a selected sub menu item from among at least one sub menu item related to the selected menu item.

5. The apparatus of claim 4, wherein the at least one processor is further configured to, based on a menu item included in the menu being selected:
search and retrieve sub menu items related to the selected menu item based on the menu history information,
identify a sub menu item with a highest connection score with the selected menu item from among the retrieved sub menu items, and
control the display to display an object corresponding to the identified sub menu item.

6. The apparatus of claim 1, wherein the at least one processor is further configured to generate menu history information based on a selection history of a menu item included in a menu of a plurality of applications.

7. The apparatus of claim 1, further comprising:
a communication interface having a circuitry,
wherein the at least one processor is further configured to, based on menu history information regarding a plurality of apparatuses being received from a server through the communication interface, update the generated menu history information based on the received menu history information.

8. The apparatus of claim 1, wherein the at least one processor is further configured to, based on a menu item included in the menu being selected by a user, update the menu history information based on the selected menu item information.

9. (canceled)

10. The apparatus of claim 1, wherein the object includes at least one of a highlight, preference information or an image of the preferred menu item.

11. A controlling method of an electronic apparatus, the method comprising:
generating menu history information based on a selection history of a menu item included in a menu of an application;
based on an event requiring menu display occurring, selecting a preferred menu item from among a plurality of menu items included in a menu that needs to be displayed based on the menu history information;
displaying an object corresponding to the preferred menu item;
based on a new application being installed, obtaining menu information of the new application;
generating recommended menu information regarding the new application by matching the menu history information and the obtained menu information; and
displaying an object in at least one menu item from among a plurality of menu items included in a menu of the new application based on the recommended menu information.

12. The method of claim 11,
wherein the menu includes a sub menu item related to a menu item included in the menu, and
wherein the generating of the menu history information comprises generating the menu history information by assigning a score to each of a menu item selected in the menu and a sub menu item related to the selected menu item.

13. The method of claim 12, further comprising:
based on a menu item included in the menu being selected, searching and displaying sub menu items related to the selected menu item;
identifying a sub menu item with a highest score from among the sub menu items; and
displaying an object corresponding to the identified sub menu item.

14. The method of claim 11,
wherein the menu includes a sub menu item related to a menu item included in the menu, and
wherein the generating of the menu history information comprises generating the menu history information by assigning a score to connection between a menu item selected in the menu and a selected sub menu item from among at least one sub menu item related to the selected menu item.

15. The method of claim 14, further comprising:
based on a menu item included in the menu being selected, searching and retrieving sub menu items related to the selected menu item based on the menu history information;
identifying a sub menu item with a highest connection score with the selected menu item from among the retrieved sub menu items; and
displaying an object corresponding to the identified sub menu item.

16. The method of claim 11, further comprising:
generating menu history information based on a selection history of a menu item included in a menu of a plurality of applications.

17. The method of claim 11, further comprising:
based on menu history information regarding a plurality of apparatuses being received from a server, updating the generated menu history information based on the received menu history information.

18. The method of claim 11, further comprising:
based on a menu item included in the menu being selected by a user, updating the menu history information based on the selected menu item information.

19. (canceled)

20. At least one non-transitory computer-readable recording medium including a program for executing a controlling method of an electronic apparatus, the method comprising:
generating menu history information based on a selection history of a menu item included in a menu of an application;
based on an event requiring menu display occurring, selecting a preferred menu item from among a plurality of menu items included in a menu that needs to be displayed based on the menu history information;
providing an object corresponding to the preferred menu item;
based on a new application being installed, obtaining menu information of the new application;
generating recommended menu information regarding the new application by matching the menu history information and the obtained menu information; and
displaying an object in at least one menu item from among a plurality of menu items included in a menu of the new application based on the recommended menu information.
